(19) United States
(12) Patent Application Publication
(10) Pub. No.: US 2010/0261862 A1
(43) Pub. Date: Oct. 14, 2010

(54) FLAME-RETARDANT PROCESSING METHOD AND FLAME-RETARDED CELLULOSIC FIBER MATERIAL

(75) Inventors: Minoru Sugiyama, Neyagawa-shi (JP); Ichiro Ozawa, Neyagawa-shi (JP); Hiroaki Inoue, Yokohama-shi (JP); Yasushi Tomotani, Osaka-shi (JP); Susumu Katsuen, Osaka-shi (JP); Kunihiro Oshima, Neyagawa-shi (JP)

Correspondence Address: BIRCH STEWART KOLASCH & BIRCH, PO BOX 747, FALLS CHURCH, VA, 22040-0747, US

(73) Assignee: KURASHIKI BOSEKI KABUSHIKI KAISHA, Kurashiki-shi (JP)

(21) Appl. No.: 12/677,219

(22) PCT Filed: Jan. 29, 2009
(86) PCT No.: PCT/JP2009/051413

§ 371 Date: Mar. 25, 2010

(30) Foreign Application Priority Data
Jan. 30, 2008 (JP) 2008-019152

(51) Int. Cl. C08B 15/06

(52) U.S. Cl. 526/238.21

(57) ABSTRACT

A flame-retardant processing method, containing:
a radiation processing step of irradiating a cellulosic fiber material with radiation;
a phosphorus processing step of adding a radically polymerizable phosphorus-containing compound to the cellulosic fiber material; and
an amine processing step of adding an amine compound to the cellulosic fiber material, and a flame-retarded cellulosic fiber material prepared by the method above.

### TECHNICAL FIELD

The present invention relates to a flame-retardant processing method and a cellulosic fiber material treated by the method.

### BACKGROUND ART

Conventional flame retardants commercially available were mainly used for treatment of polyester fibers and cannot be used in processing of natural fibers such as cotton and hemp and cellulosic fibers represented by regenerated fibers such as rayon. In addition, conventional flame retardants had problems such as insufficient flame resistant properties and high concentration of formaldehyde released therefrom, and there is no flame retardant that can be used, for example, on clothes that demand sufficiently high flame retardance and safety to the skin.

Methods of irradiating a fibrous material with radiation before or/and after addition of a flame retardant thereto were proposed as the flame-retardant processing methods (Patent Documents 1 to 4). The flame retardants used were, for example, vinyl phosphonate oligomers, vinyl phosphonate, phosphite compounds, vinyl phosphate compounds and the like.

### Patent Document 1: JP-B No. 1-20268

### Patent Document 2: JP-A No. 5-163673

### Patent Document 3: JP-A No. 2001-254272

### Patent Document 4: JP-A No. 2006-183166

### DISCLOSURE OF THE INVENTION

### Problems to be Solved by the Invention

However, fabrics treated by the conventional methods were not sufficient in flame retardance. There was a problem that, even if a fabric shows preferable flame retardance immediately after treatment, the flame retardance declines when it is washed. Washing of treated fabrics leads to distinct deterioration in the flame retardance. There was also a problem that hand feeling of the treated fabric becomes harder.

It is an object of the present invention to provide a flame-retardant processing method and a flame-retarding agent set for radiation treatment that can provide a sufficient flame retardance, and a flame-retarded cellulosic fiber material with sufficient flame retardance.

Another object of the present invention is to provide a flame-retardant processing method and a flame-retarding agent set for radiation treatment that can provide a sufficient flame retardance and a superior hand feeling, and a flame-retarded cellulosic fiber material with sufficient flame retardance and superior hand feeling.

In the present description, the flame retardance means a property to make a fiber less combustible or a property to make a fiber resistant to spreading of flame even if ignited.

### Means to Solve the Problems

The present invention relates to a flame-retardant processing method, comprising:

a radiation processing step of irradiating a cellulosic fiber material with radiation;

a phosphorus processing step of adding a radically polymerizable phosphorus-containing compound to the cellulosic fiber material; and

an amine processing step of adding an amine compound to the cellulosic fiber material.

The present invention also relates to a flame-retarded cellulosic fiber material, prepared by binding a radically polymerizable phosphorus-containing compound to a cellulosic fiber in addition reaction and binding an amine compound ionically to the bound and radically polymerizable phosphorus-containing compound.

The present invention also relates to a flame-retarding agent set for radiation treatment, comprising a radically polymerizable phosphorus-containing compound and an amine compound.

### EFFECT OF THE INVENTION

It is possible according to the flame-retardant processing method of the present invention to provide a cellulosic fiber material with improved flame retardance sufficiently, i.e., improved initial flame retardance and durability in flame retardance during washing. It is also possible to retain preferable hand feeling of the cellulosic fiber material sufficiently by controlling pH of a processing solution, a phosphorus content of a flame-retarded raw material and others.

### BEST MODE FOR CARRYING OUT THE INVENTION

The flame-retardant processing method according to the present invention is characterized by comprising:

a radiation processing step of irradiating a cellulosic fiber material with radiation;

a phosphorus processing step of adding a radically polymerizable phosphorus-containing compound to the cellulosic fiber material; and

an amine processing step of adding an amine compound to the cellulosic fiber material.

The cellulosic fiber material to which the method according to the present invention is applied (hereinafter, referred to simply as fibrous material) is not particularly limited, if it is a raw material containing a cellulosic fiber. Examples of the cellulosic fibers include natural fibers such as cotton, linen, ramie, and other plant fibers, regenerated fibers such as rayon, polynosic, Modal, cupra and Tencel, semi-synthetic fibers including cellulosic fibers such as triacetate and diacetate; and the like. In particular, cellulosic fibers including natural cellulosic fibers, regenerated cellulosic fibers and cellulose derivatives such as acetate are preferable. The natural celluloses above include not only natural celluloses, but also mercerized celluloses and those treated with liquid ammonia. Examples of other fibers that may be included in the cellulosic fiber materials include animal fibers such as wool, mohair, cashmere and others; synthetic fibers such as polyester, polyethylene, polypropylene and acryl; and the like. The fibrous material may be in any shape, for example in the shape of cotton; in the shape of a yarn such as spun yarn, blended yarn or composite yarn; in the shape a fabric such as woven fabric, knitted fabric, or nonwoven fabric; or in the shape of a fiber product produced from the fabric.

The content of the cellulosic fiber in the cellulosic fiber material is normally 20 wt % or more, and preferably 50 wt % or more and more preferably 100% for further improvement in flame retardance.

In the present invention, the radiation processing step, the phosphorus processing step and the amine processing step may be carried out in any order. It is possible to provide sufficient flame retardance, even if the steps are carried out in any order. It is possibly because the radically polymerizable phosphorus-containing compound binds to the cellulosic fiber in addition reaction and the amine compound reacts with the bound and radically polymerizable phosphorus-containing compound region, even if the steps are carried out in any order. For example, if the phosphorus processing step is carried out before or after the radiation processing step, the radically polymerizable phosphorus-containing compound binds to the cellulosic fiber in addition reaction. The amine compound reacts with the regions of the radically polymerizable phosphorus-containing compound rapidly, when such bonds are formed in the presence of the amine compound. On the other hand, even if the amine processing step is carried out after formation of such bonds, the amine compound can react with the regions of the bound and radically polymerizable phosphorus-containing compound rapidly.

In the present invention, the detailed mechanism of the expression of flame retardance is yet to be understood, but may be based on the following mechanism: The fibrous material prepared by application of the method according to the present invention releases the amine compound region rapidly, decomposes the phosphorus-containing compound region in the combustion field to form phosphorus pentoxide, and thus forms a carbonized film on the surface of the cellulosic fiber. The carbonized film formed exhibits not only an adiabatic action of suppressing heat transfer into fiber, but also a shielding action of preventing diffusion of the combustible decomposition products generated within the fiber into the combustion field, thus preventing combustion by firing and exhibiting flame retardance. In addition, the amine compound regions are not substituted by sodium and calcium ions derived from laundry agent and water during washing, and possibly in this way, the flame retardance is improved drastically after washing. In the present invention, even when the bottom end of a vertically placed fibrous material is ignited with a flame blown vertically out of a gas burner according to vertical methane burner method, the raw material is carbonized, preventing combustion sufficiently. In the absence of the amine treatment, sodium and calcium ions and others derived from laundry agents and water react with and are adsorbed on the phosphorus-containing compound regions during washing. Such a fibrous material is resistant to release of sodium and calcium in the combustion field, inhibiting decomposition of the phosphorus compound and thus, reducing the flame retardance after washing.

In the present invention, a crosslinking step may be added for improvement of washing durability. The crosslinking step is preferably carried out after the radiation processing step, the phosphorus processing step and the amine processing step. After reaction with the amine compound and the radically polymerizable phosphorus-containing compound, the crosslinking compound crosslinks an amine compound with another amine compound by using excessive amino groups, thus further improving the flame-resisting action after washing.

Typical examples of the orders of the radiation processing step, the phosphorus processing step and the amine processing step include the followings:

(1) Radiation processing step-phosphorus processing step-amine processing step;
(2) Amine processing step-radiation processing step-phosphorus processing step;
(3) Radiation processing step-simultaneous phosphorus and amine treatment step in the same bath;
(4) Phosphorus processing step-radiation processing step-amine processing step;
(5) Amine processing step-phosphorus processing step-radiation processing step;
(6) Simultaneous phosphorus and amine treatment step in the same bath-radiation processing step; and
(7) Phosphorus processing step-amine processing step-radiation processing step.
A crosslinking step may be added after the steps of (1) to (7).

The phosphorus processing step is preferably carried out after the radiation processing step, for suppression of polymerization of the radically polymerizable phosphorus-containing compounds unbound to the fibrous material. In such a case, the amine treatment may be carried out before the radiation processing step, simultaneously with the phosphorus processing step in the same bath, or after the phosphorus processing step. Examples of the preferable operational order are the orders (1) to (3), and in particular, the orders (1) and (2) are preferable for suppression of the reaction between the free-radically polymerizable phosphorus-containing compound and the amine compound with the simultaneous processing solution in the same bath.

Embodiments of the present invention when each of the orders above is employed will be described.

### First Embodiment

The first embodiment of the present invention employs the order (1) above.

Radiation Processing Step

First in the embodiment, the fibrous material is irradiated with a radiation. The irradiation makes it possible for the radically polymerizable phosphorus-containing compound to bind to the fibrous material chemically in addition reaction of the radically polymerizable groups in the phosphorus processing step described below. The radiation treatment generates radicals on the cellulosic fiber, and the generated radicals form chemical bonds of the radically polymerizable groups of the phosphorus-containing compound with the cellulosic fiber in the phosphorus processing step. The radicals on the cellulosic fiber are generated easily at the 5th carbon, and then at the 4th and 1st carbons, of the structural unit of the cellulose molecule, and the radicals are considered to be generated also at the 2nd, 3rd and 6th carbons. The radically polymerizable phosphorus-containing compound may bind to any carbon.

Examples of the radiation for use include particle beams such as electron beam, beta ray and alpha ray; ionizing radiation such as ultraviolet, X ray and gamma ray; and the like. In particular, use of electron beam is preferable from the viewpoint of easiness in handling, stability, and efficiency of radical generation.

The irradiation conditions of one time by the radiation are not particularly limited, if the bonds between the cellulosic fiber and the phosphorus-containing compound are formed, and for example, the irradiation may be carried out under strong conditions for a short period or under weak conditions for a long period. Specifically, when electron beam is irradiated, the exposure dose is normally 1 to 200 kGy, preferably 5 to 100 kGy, more preferably 10 to 50 kGy.

In particular, when electron beam is irradiated, the irradiation is preferably carried out under nitrogen atmosphere, and the electron beam may be irradiated on one side of raw materials, because the electron beam penetrates therein, but an additional radiation treatment is preferably carried out after the radiation, phosphorus and amine treatments according to the present invention, to make the treatment according to the present invention more reliable. If the radiation is irradiated additionally, the second irradiation is preferably carried out on the side opposite to the first irradiation side. If a crosslinking treatment is carried out, the second radiation treatment is preferably carried out before the crosslinking treatment.

Any electron beam irradiation equipment commercially available may be used and, for example, an electrocurtain-type electron beam irradiation equipment such as EC250/15/180L (manufactured by Iwasaki Electric Co., Ltd.), EC300/165/800 (manufactured by Iwasaki Electric Co., Ltd.), or EPS300 (manufactured by NHV Corporation) is used.

Phosphorus Processing Step

A radically polymerizable phosphorus-containing compound is then added to the fibrous material. The radicals generated on the fiber transfer, as they are used as start points, to the radically polymerizable groups of the phosphorus-containing compound, consequently forming chemical bonds between the phosphorus-containing compounds and the cellulosic fiber. The radical transferred to a radically polymerizable group of the phosphorus-containing compound binds to the radically polymerizable group of another phosphorus-containing compound, which may occur in chained manner. If the chain reaction progresses to some extent, termination reactions occur by binding between terminal radicals and also between the terminal radical and other cellulose radicals.

The radically polymerizable phosphorus-containing compound (may be referred to simply as phosphorus-containing compound in the present description) is a compound containing a radically polymerizable group and a phosphorus atom in the molecule. The radically polymerizable group is a functional group having a radically-polymerizable carbon-carbon double bond, and examples thereof include vinyl, (meth)acryloyl, allyl and other groups.

The phosphorus-containing compound for use is, for example, an unsaturated organic phosphoric ester, and typical examples thereof preferably used include vinyl phosphate compounds represented by General Formula (1) (hereinafter, referred to as vinyl phosphate compounds (1)).

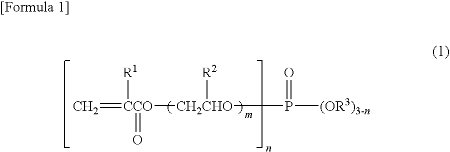

In General Formula (1), R¹ and R² each independently represent a hydrogen atom or a methyl group; preferably, R¹ represents a methyl group and R² a hydrogen atom.

R³ represents a hydrogen atom or an alkyl group having 1 to 6 carbon atoms or allyl group that may have a substituent, preferably a hydrogen atom.

The letter “n” means 1 or 2.

The letter “m” means an integer of 1 to 6, preferably an integer of 1 to 3, and more preferably 1.

For example, the bonding formation formed when the vinyl phosphate compound (1) wherein n=1 is bound to the fibrous material is described below. In the present description, the term “Cell” represents cellulose.

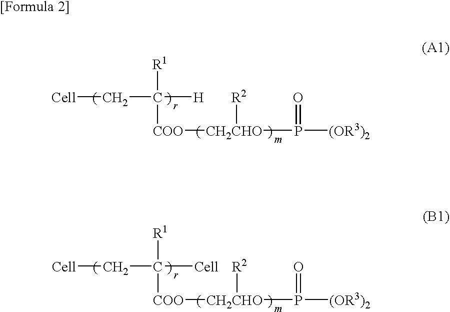

R¹, R², R³, n, m and r in General Formulae (A1) and (B1) are respectively the followings:

R¹, R², R³, n and m are the same as those described in General Formula (I).

The letter “r” means an integer of 1 or more.

Typical examples of preferable vinyl phosphate compounds (1) include mono(2-acryloyloxyethyl) phosphate, mono(2-methacryloyloxyethyl) phosphate, bis(2-acryloyloxyethyl) phosphate, bis(2-methacryloyloxyethyl) phosphate, diethyl-(2-acryloyloxyethyl) phosphate, diethyl-(2-methacryloyloxyethyl) phosphate, diphenyl-(2-acryloyloxyethyl) phosphate, diphenyl-(2-methacryloyloxyethyl) phosphate, polyalkylene glycol (2-acryloyloxyethyl) phosphate, polyalkylene glycol (2-methacryloyloxyethyl) phosphate and the like.

Vinyl phosphate compounds are commercially available.

For example, mono(2-methacryloyloxyethyl) phosphate and bis(2-methacryloyloxyethyl) phosphate are available from Sigma Aldrich Japan K.K. and Kyoeisha Chemical Co., Ltd.

For example, a mixture of mono(2-methacryloyloxyethyl) phosphate and bis(2-methacryloyloxyethyl) phosphate is available as “ALBRITECT™6835” (manufactured by Rhodia Nicca, Ltd.).

For example, mono(2-methacryloyloxyethyl) phosphate is available as “Phosmer M” (manufactured by Uni-Chemical Co., Ltd.).

For example, polyalkylene glycol (2-acryloyloxyethyl) phosphate is available as “SIPOMER PAM-100” (manufactured by Rhodia Nicca, Ltd.).

For example, polyethylene glycol (2-methacryloyloxyethyl) phosphate is available as “Phosmer PE” (manufactured by Uni-Chemical Co., Ltd.).

The phosphorus-containing compound is normally added to the fibrous material in the form of aqueous solution. The concentration of the phosphorus-containing compound in the aqueous solution is not particularly limited, if the object of the present invention is achieved, and preferably, for example, 10 to 70 wt %, particularly 20 to 60 wt % with respect to the total amount of the aqueous solution. A phosphorus-containing compound may be used alone, or two or more kinds of them may be used in combination. If two or more phosphorus-containing compounds are used, the total amount thereof is preferably in the range above.

The method of adding the phosphorus-containing compound is not particularly limited, if the raw material is dipped with the aqueous solution, and, for example, a method of dipping the raw material in the aqueous solution and squeezing it, a method of coating the aqueous solution on the material, a method of spraying the aqueous solution thereon, or the like may be used. It is preferable to employ the method of dipping the raw material in the aqueous solution and squeezing it, for imparting the flame retardance easily and uniformly.

The pick up of the aqueous phosphorus-containing compound solution into the raw material is not particularly limited, if the object of the present invention is achieved, and normally, may be lower when the concentration of the phosphorus-containing compound in the aqueous solution is larger. When the concentration of the phosphorus-containing compound is lower, the pick up is set to a larger value. For example when the aqueous solution concentration is set to the concentration described above, the pick up is normally set to 50 to 100 wt %, preferably 60 to 80 wt %. The temperature of the aqueous phosphorus-containing compound solution is not particularly limited, and may be, for example, room temperature.

In the present description, the pick up is defined as an add-on rate of the aqueous solution with respect to the weight of the raw material in dry state.

When a method of dipping the raw material in an aqueous solution and squeezing it is used as the method of adding the aqueous phosphorus-containing compound solution, the dipped raw material is squeezed until the pick up is achieved. The squeezing method for use is preferably a mangle-squeezing method from the view point of uniformity.

The aqueous phosphorus-containing compound solution may contain additional compounds conventionally used as flame retardants for fibers, pH adjusters, organic solvents and surfactants, if the object of the present invention is achieved.

Addition of a pH adjuster is effective for retaining the fabric strength of the flame-retarded raw material and for adjusting a pH of the aqueous solution to neutrality. A pH adjuster used is an amine compound described below, preferably ammonia. For example, if a vinyl phosphate compound (1) is used in an amount of 25 to 35 wt % and ammonia is used as the pH adjuster, the ammonia is used at a concentration of less than 3 wt %, in particular of 0.5 to 2 wt %.

Examples of the organic solvents for use include methanol, ethanol, 1-propanol, 2-propanol, n-butanol, dimethylformamide, dioxane, dimethylsulfoxide, benzene, toluene, xylene and the like.

In the phosphorus processing step, an aging treatment is preferably carried out after the phosphorus treatment.

The aging treatment is a treatment to promote the reaction by keeping the processing solution in a temperature state raised to some extent, for example at 20 to 50° C. It is possible in this way to bring the reaction between the cellulosic fiber and the phosphorus-containing compound into the saturation state. For example, the raw material to which the aqueous processing agent solution is added is stored for about 1 minute to 24 hours. In the present embodiment, an additional radiation treatment is preferably carried out, after the phosphorus processing step, in particular after the aging treatment in the phosphorus processing step and before the water washing treatment. The treatment promotes chemical binding of the phosphorus-containing compound to the fibrous material, enabling more effective expression of preferable flame retardance. The additional radiation treatment may be carried out by a method similar to that in the radiation processing step before the phosphorus processing step. An aging treatment is more preferably carried out, immediately after the additional radiation treatment.

Amine Processing Step

An amine compound is then added to the fibrous material. The amine compound reacts with the phosphorus-containing compound regions bound to the cellulosic fiber rapidly, consequently forming ionic bonds.

The amine compound is not particularly limited, if it is a compound that can form ammonium ion in water, and examples of the compounds for use include relatively low-molecular weight amines to relatively high-molecular weight amines. Among amine compounds, those having a molecular weight of less than 300 are called low-molecular weight compounds, while those having a molecular weight of 300 or more are called high-molecular weight compounds.

The ammonium ion group [—N⁺(R)₃] of the amine compound generated in water is a monovalent positive group. On the other hand, the phosphorus-containing compound region bound to the cellulosic fiber, for example the —OR³ group in General Formulae (A1) and (B1) above, generates a monovalent negative group [—O⁻ group] in water. Thus, these groups bind to each other electrically, resulting in formation of ionic bonds between the amine compound and the phosphorus-containing compound region.

Typical examples of the preferable low-molecular weight amine compounds include ammonia; ammonium salts such as tetraethylammonium hydroxide; aliphatic monoamines such as ethylamine, monoethanolamine, diethylamine, triethylamine, glycine, and guanidine carbonate; aromatic monoamines such as aniline and benzylamine; heterocyclic monoamines such as imidazole; aliphatic polyamines such as ethylenediamine, hexamethylenediamine, diethylenetriamine, triethylenetetramine and guanidine; aromatic polyamines such as phenylenediamine; heterocyclic polyamines such as piperazine and N-aminoethylpiperazine; and the like. The low-molecular weight amine compound has preferably amino groups as many as possible in the molecule for further improvement in flame retardance and also in hand feeling of the treated fibrous material.

An amino-group-containing polymer is used as the high-molecular weight amine compound, and typical preferable examples thereof include polyethyleneimine, dicyandiamide-alkylene (polyamine) condensates and the like. The molecular weight of the high-molecular weight amine compound is not particularly limited, if it is soluble in water at a particular concentration, and normally 300 to 100,000, particularly 500 to 5000, as weight-average molecular weight. The weight-average molecular weight in the present description is a value determined by a chromatographic method.

Polyethyleneimines are available, for example, as Epomin SP series products manufactured by Nippon Shokubai Co., Ltd. Typical examples thereof include Epomin SP-003, SP-006, SP-012, SP-018, SP-200, P-1000 and the like.

Polyallylamines are available, for example, as PAA series products manufactured by Nitto Boseki Co. Ltd. Typical examples thereof include PAA-01, PAA-03, PAA-05, PAA-08, PAA-15C, PAA-25 and the like.

The dicyandiamide-formalin condensates are available, for example, as Neofix F manufactured by Nicca Chemical Co., Ltd.

The dicyandiamide-alkylene (polyamine) condensates are available, for example, as Fix SK-30 manufactured by Satoda Chemical Industrial Co., Ltd.

One or more compounds selected from the group consisting of ammonia, aliphatic monoamines, aliphatic polyamines, and amino-group-containing polymers (in particular, polyethyleneimine, polyallylamine and dicyandiamide-formalin condensates) are preferably used, and more preferably amino-group-containing polymers are used, as the amine compounds, for further improvement in flame retardancy and in hand feeling of the treated fibrous material.

If the crosslinking step is carried out, the amine compound is preferably a primary or secondary amine compound, and, for example, use of polyallylamine as a primary amine or polyethyleneimine as a secondary amine is preferable.

The amine compound is normally added to the fibrous material in the form of aqueous solution. The concentration of the amine compound in the aqueous solution is not particularly limited, if the object of the present invention is achieved, and may be, for example, about 5 to 30 wt % with respect to the total amount of the aqueous solution. An amine compound may be used alone, or two or more amine compounds may be used in combination. If two or more amine compounds are used, the total amount thereof is preferably in the range above.

The method of adding the amine compound is not particularly limited, if the raw material is dipped with the aqueous solution, and an addition method similar to that of the phosphorus-containing compound may be adopted. For example, it is preferable to use of a method of treating the raw material in an aqueous solution at a particular temperature (40 to 80° C.) for a particular period (10 to 120 minutes), a method of dipping the raw material in an aqueous solution, squeezing it, and treating it at a particular temperature (30 to 70° C.) for a particular period (1 to 24 hours), or a method of dipping the raw material in an aqueous solution and squeezing it.

The pick up of the aqueous amine compound solution into the raw material is not particularly limited, if the object of the present invention is achieved, and normally, the pick up may be smaller, when the amine compound concentration in the aqueous solution is higher. On the other hand, when the amine compound concentration is lower, the pick up is set to a larger value. For example, when the concentration of the aqueous solution is set to the concentration described above, the pick up is normally set to 50 to 100 wt %, preferably 60 to 80 wt %. The temperature of the aqueous amine compound solution is not particularly limited, and may be, for example, room temperature.

When a method of dipping the raw material in an aqueous solution and squeezing it is used as the method of adding the aqueous amine compound solution, the dipped raw material is squeezed until the pick up above is achieved, and the squeezing method for use is preferably a mangle-squeezing method.

The aqueous amine compound solution may contain organic solvents and surfactants, if the object of the present invention is achieved. The organic solvents for use are those similar to the organic solvents that may be contained in the aqueous phosphorus-containing compound solution.

In the amine processing step, an aging treatment is carried out after the amine treatment by a method similar to that in the phosphorus processing step and preferably a water-washing treatment is additionally carried out. The aging treatment brings the reaction between the phosphorus-containing compound regions bound to the cellulosic fiber and the amine compound into the saturation state. The water-washing treatment can remove the unreacted phosphorus-containing compound and the processing agents such as amine compound.

After the water-washing treatment, normally drying is carried out. The drying is performed, for example, by storing the fibrous material at 20 to 85° C. for 0.5 to 24 hours.

In the present embodiment, an additional radiation treatment is preferably carried out between the phosphorus processing step and the amine processing step, in particular after aging treatment of the phosphorus processing step and before the amine processing step. The treatment promotes chemical binding of the phosphorus-containing compound to the fibrous material, enabling more effective expression of flame retardance. The additional radiation treatment can be performed by a method similar to that in the radiation processing step described above. An aging treatment is more preferably carried out, immediately after the additional radiation treatment by a method similar to the aging treatment in the phosphorus processing step.

### Second Embodiment

The second embodiment of the present invention employs the order (2). Hereinafter, each step in the second embodiment will be described, but the each step is identical with that in the first embodiment, except that the operational order is different, unless otherwise indicated.

Amine Processing Step

First in the embodiment, an amine compound is added to the fibrous material. The amine compound added in this step reacts rapidly with the phosphorus-containing compound regions bound to the cellulosic fiber in the subsequent radiation and also phosphorus processing steps, if it is present on the surface of the cellulosic fiber.

In the present step, an aging treatment is preferably carried out after amine treatment, by a method similar to the aging treatment in the phosphorus processing step of the first embodiment, but a water-washing treatment is preferably eliminated. It is because the water-washing treatment removes the amine compound from the fibrous material. The aging treatment allows effective retention of the amine compound in the fibrous material.

Radiation Processing Step

A radiation is then irradiated to the fibrous material. It generates radicals on the cellulosic fiber even in the presence of the amine compound, and the phosphorus-containing compound possibly binds to the fibrous material in addition reaction of the radically polymerizable groups in the phosphorus processing step.

Phosphorus Processing Step

A phosphorus-containing compound is then added to the fibrous material. Even in the presence of the amine compound, the radicals generated on the fiber in the previous step as the start points transfer to the radically polymerizable groups of the phosphorus-containing compound, consequently causing chemical binding between the phosphorus-containing compounds and the cellulosic fiber and reaction of the amine compound to the bound phosphorus-containing compound regions.

In the present step, an aging treatment is carried out after the phosphorus treatment by a method similar to the aging treatment in the phosphorous processing step of the first embodiment and preferably a water-washing treatment is additionally carried out. The aging treatment brings the reaction between the phosphorus-containing compound regions bound to the cellulosic fiber and the amine compound into the saturation state and also the reaction between the phosphorus-containing compound regions bound to the cellulosic fiber and the amine compound into the saturation state. The water-washing treatment removes the unreacted phosphorus-containing compound and the processing agents such as amine compounds. After the water-washing treatment, normally drying is carried out. The drying is performed, for example, by storing the fibrous material at 20 to 85° C. for 0.5 to 24 hours.

In the present embodiment, an additional radiation treatment is preferably carried out again after the phosphorus processing step, in particular after aging treatment in the phosphorus processing step and before the water-washing treatment. The treatment promotes chemical binding of the phosphorus-containing compound to the fibrous material and reaction of the phosphorus-containing compound region to the amine compound, enabling more effective expression of flame retardance. The additional radiation treatment can be performed by a method similar to that in the radiation processing step of the first embodiment. An aging treatment is more preferably carried out immediately after the additional radiation treatment by a method similar to that in the phosphorus processing step of the first embodiment.

### Third Embodiment

The third embodiment of the present invention employs the order (3). Hereinafter, each step in the third embodiment will be described, but the each step is identical with that in the first embodiment, except that the operational order is different, unless otherwise indicated.

Radiation Processing Step

First in the present embodiment, a radiation is irradiated to the fibrous material. It generates radicals on the cellulosic fiber, enabling the phosphorus-containing compound to bind chemically to the cellulosic fiber in addition reaction by the radically polymerizable groups in the single-bath processing step described below.

Single-Bath Processing Step

A phosphorus-containing compound and an amine compound are then added to the cellulosic fiber material simultaneously. The phosphorus treatment of binding the phosphorus-containing compound to the cellulosic fiber and the amine treatment of reacting the bound phosphorus-containing compound region with the amine compound are carried out in a single bath.

The single-bath processing method is the same as the processing method in the phosphorus processing step of the first embodiment, except that the amine compound used in the amine processing step of the first embodiment is mixed with and dissolved in the aqueous phosphorus-containing compound solution. For example, the aqueous solution used in the single-bath treatment is the same as the aqueous phosphorus-containing compound solution used in the phosphorus processing step of the first embodiment, except that the amine compound used in the amine processing step is mixed with and dissolved in the aqueous phosphorus-containing compound solution. In this way, the phosphorus-containing compound binds chemically to the cellulosic fiber in addition reaction by the radically polymerizable groups and the phosphorus-containing compound regions bound to the cellulosic fiber react with the amine compound rapidly.

The amine compound concentration in the aqueous solution used in this step is the same as that of the aqueous amine compound solution used in the amine processing step of the first embodiment.

In the present step, an aging treatment is carried out after single-bath treatment by a method similar to the aging treatment in the phosphorus processing step of the first embodiment, and preferably a water-washing treatment is additionally carried out. The aging treatment brings the reaction between the cellulosic fiber and the phosphorus-containing compound into the saturation state and also the reaction between the phosphorus-containing compound regions bound to the cellulosic fiber and the amine compound into the saturation state. The water-washing treatment removes the unreacted phosphorus-containing compound and the processing agents such as amine compounds. After the water-washing treatment, normally drying is carried out. The drying is performed, for example, by storing the fibrous material at 20 to 85° C. for 0.5 to 24 hours.

In the present embodiment, an additional radiation treatment is preferably carried out after the single-bath processing step, in particular after aging treatment in the single-bath processing step and before water-washing treatment. The treatment promotes chemical binding of the phosphorus-containing compound to the fibrous material and reaction of the phosphorus-containing compound regions to the amine compound, enabling more effective expression of flame retardance. The additional radiation treatment can be performed by a method similar to that in the radiation processing step of the first embodiment. An aging treatment is more preferably carried out immediately after the additional radiation treatment by a method similar to the aging treatment in the phosphorus processing step of the first embodiment.

### Fourth Embodiment

The fourth embodiment of the present invention employs the order (4). Hereinafter, each step in the fourth embodiment will be described, but the each step is identical with that in the first embodiment, except that the operational order is different, unless otherwise indicated.

Phosphorus Processing Step

First in the embodiment, a phosphorus-containing compound is added to the fibrous material. It leads to retention of the phosphorus-containing compound in the fibrous material, making the phosphorus-containing compound chemically bind to the cellulosic fiber in the radiation processing step described below.

In the present step, an aging treatment is preferably carried out after the phosphorus treatment by a method similar to the aging treatment in the phosphorus processing step of the first embodiment, but a water-washing treatment is preferably eliminated. It is because the water-washing treatment, if performed, removes the phosphorus-containing compound from the fibrous material. The aging treatment makes the phosphorus-containing compound retained in the fibrous material effectively.

Radiation Processing Step

A radiation is then irradiated to the fibrous material. It generates radicals on the cellulosic fiber, enabling the phosphorus-containing compound retained in the phosphorus processing step to bind chemically to the fibrous material in addition reaction by the radically polymerizable groups.

In the present step, an aging treatment is preferably carried out after radiation treatment by a method similar to the aging treatment in the phosphorus processing step of the first embodiment. The aging treatment brings the reaction between the cellulosic fiber and the phosphorus-containing compound into the saturation state.

Amine Processing Step

An amine compound is then added to the fibrous material. The amine compound added in this step reacts with the phosphorus-containing compound regions bound to the cellulosic fiber rapidly.

In the present step, an aging treatment is carried out after the amine treatment by a method similar to the aging treatment in the phosphorus processing step of the first embodiment, and preferably a water-washing treatment is additionally carried out. The aging treatment brings the reaction between the phosphorus-containing compound regions bound to the cellulosic fiber and the amine compound into the saturation state. The water-washing treatment removes the unreacted phosphorus-containing compound and the processing agents such as amine compounds. After the water-washing treatment, normally drying is carried out. The drying is performed, for example, by storing the fibrous material at 20 to 85° C. for 0.5 to 24 hours.

### Fifth Embodiment

The fifth embodiment of the present invention employs the order (5). Hereinafter, each step in the fifth embodiment will be described, but the each step is identical with that in the first embodiment, except that the operational order is different, unless otherwise indicated.

Amine Processing Step

First in the embodiment, an amine compound is added to the fibrous material. The amine compound added in this step reacts rapidly with the phosphorus-containing compound regions bound to the cellulosic fiber, as it is left on the surface of the cellulosic fiber also in the subsequent radiation processing step.

In the present step, an aging treatment is preferably carried out after the amine treatment by a method similar to the aging treatment in the phosphorus processing step of the first embodiment, but a water-washing treatment is preferably eliminated. It is because the water-washing treatment removes the amine compound from the fibrous material. The aging treatment allows effective retention of the amine compound in the fibrous material.

Phosphorus Processing Step

A phosphorus-containing compound is then added to the fibrous material. The phosphorus-containing compound added in this step can be bound to the cellulosic fiber chemically, as it is left on the surface of the cellulosic fiber surface also in the subsequent radiation processing step.

In the present step, an aging treatment is preferably carried out after the phosphorus treatment by a method similar to the aging treatment in the phosphorus processing step of the first embodiment, but a water-washing treatment is preferably eliminated. It is because the water-washing treatment removes the phosphorus compound from the fibrous material. The aging treatment allows effective retention of the phosphorus-containing compound in the fibrous material.

Radiation Processing Step

A radiation is then irradiated to the fibrous material. It generates radicals on the cellulosic fiber, enabling the phosphorus-containing compound retained in the phosphorus processing step to bind chemically to the fibrous material in addition reaction by the radically polymerizable groups and the amine compound retained in the amine processing step to react with the bound phosphorus-containing compound regions.

In the present step, an aging treatment is preferably carried out after radiation treatment by a method similar to that in the phosphorus processing step of the first embodiment and preferably a water-washing treatment is additionally carried out. The aging treatment brings the reaction between the cellulosic fiber and the phosphorus-containing compound into the saturation state and also the reaction between the phosphorus-containing compound regions bound to the cellulosic fiber and the amine compound into the saturation state. The water-washing treatment removes the unreacted phosphorus-containing compound and the processing agents such as amine compounds. After the water-washing treatment, normally drying is carried out. The drying is performed, for example, by storing the fibrous material at 20 to 85° C. for 0.5 to 24 hours.

### Sixth Embodiment

The sixth embodiment of the present invention employs the order (6). Hereinafter, each step in the sixth embodiment will be described, but the each step is identical with that in the first embodiment, except that the operational order is different, unless otherwise indicated.

Single-Bath Processing Step

First in the embodiment, a phosphorus-containing compound and an amine compound are added simultaneously to the cellulosic fiber material. The phosphorus-containing compound can bind chemically with the cellulosic fiber in addition reaction by the radically polymerizable groups and the phosphorus-containing compound regions bound to the cellulosic fiber can react with the amine compound rapidly, as the phosphorus-containing compound and the amine compound added in this step are left on the surface of the cellulosic fiber also in the subsequent radiation processing step.

In the present step, an aging treatment is preferably carried out after single-bath treatment by a method similar to the aging treatment in the phosphorus processing step of the first embodiment, but a water-washing treatment is preferably eliminated. It is because the water-washing treatment removes the phosphorus-containing compound and the amine compound from the fibrous material. The aging treatment allows effective retention of the phosphorus-containing compound and the amine compound in the fibrous material.

Radiation Processing Step

A radiation is then irradiated to the fibrous material. It generates radicals on the cellulosic fiber, enabling the phosphorus-containing compound retained in the single-bath processing step to bind chemically to the fibrous material in addition reaction by the radically polymerizable groups and the amine compound retained in the same step to react with the bound phosphorus-containing compound regions.

In the present step, an aging treatment is preferably carried out after radiation treatment by a method similar to that in the phosphorus processing step of the first embodiment and preferably a water-washing treatment is additionally carried out. The aging treatment brings the reaction between the cellulosic fiber and the phosphorus-containing compound into the saturation state and the reaction between the phosphorus-containing compound regions bound to the cellulosic fiber and the amine compound also into the saturation state. The water-washing treatment removes the unreacted phosphorus-containing compound and the processing agents such as amine compounds. After the water-washing treatment, normally drying is carried out. The drying is performed, for example, by storing the fibrous material at 20 to 85° C. for 0.5 to 24 hours.

### Seventh Embodiment

The seventh embodiment of the present invention employs the order (7). Description of each step in the seventh embodiment will be omitted, because the each step is identical with that in the fifth embodiment, except that the operational order is different.

The flame-retarded cellulosic fiber material treated by the method described in any one of the embodiments above is considered to have a structure in which the phosphorus-containing compound is bound to the cellulosic fiber in addition reaction and the bound phosphorus-containing compound regions have ionic bonds formed in reaction with the amine compound.

The phosphorus content in the cellulosic fiber material according to the present invention is not particularly limited, if the object of the present invention is achieved, but, in the present invention, the cellulosic fiber material shows superior flame retardance even at a relatively low phosphorous content. In addition, the phosphorus content is preferably lower from the viewpoint of hand feeling of the treated fibrous material. The phosphorus content in the fibrous material according to the present invention is preferably 2.0 wt % or less, particularly preferably 0.1 to 1.3 wt %, and still more preferably 0.1 to 1.0 wt %, from the viewpoint of the balance between flame retardance and hand feeling. The phosphorus content can be controlled by adjusting the processing concentration of the phosphorus-containing compound and the pick up during the treatments. The present invention does not exclude a phosphorus content of higher than the range above, and thus, the fibrous material according to the present invention shows superior flame retardance even at a phosphorus content of higher than the range above.

The phosphorus content is a rate of phosphorus atoms contained in or bound to the fibrous material after flame-retardant processing, i.e., the content of the phosphorus atoms with respect to the total amount of the raw materials.

The phosphorus content used in the present description is a value obtained by using a scanning fluorescent X-ray analyzer ZSX 100e (manufactured by Rigaku Corporation), but the analyzer is not particularly limited thereto, if it is an analyzer employing the fluorescent X-ray analysis method.

The flame-retarding agent set for radiation treatment according to the present invention contains a phosphorus-containing compound and an amine compound, and these compounds may be separately stored or previously mixed with each other. The flame-retarding agent set containing a phosphorus-containing compound and an amine compound separately can be used in the flame-retardant processing method employing any one of the orders (1), (2), (4), (5) and (7). Specifically, these compounds may be dissolved separately, respectively to particular concentrations, to give aqueous solutions, which are used in the flame-retardant processing method. The flame-retarding agent set containing a phosphorus-containing compound and an amine compound that are previously mixed can be used in the flame-retardant processing method employing any one of the orders (3) and (6). Specifically, these compounds are mixed at a particular ratio and dissolved in water, to give an aqueous solution containing them at particular concentrations, and the solution may be used in the flame-retardant processing method.

Crosslinking Step

Hereinafter, the crosslinking step, if performed, will be described. As described above, the crosslinking step is carried out after the radiation processing step, the phosphorus processing step and the amine processing step.

The crosslinking compound for use in the present invention is not particularly limited, if it is a compound forming crosslinking bonds between amino groups. The crosslinking compound, if it has two or more functional groups reactive with amino groups, can crosslink amine compounds.

Examples of the crosslinking compounds include multifunctional epoxy group-containing compounds, glyoxal resins and the like. The multifunctional epoxy compounds are commercially available, for example, as Denacol series manufactured by Nagase Chemtex Corporation. Typical examples thereof include Denacol EX-851, EX-313, EX-314, EX-421, EX-521, EX-612 and the like.

The crosslinking compound is normally added to the fibrous material in the form of aqueous solution. The concentration of the crosslinking compound in the aqueous solution is not particularly limited, if the object of the present invention is achieved, and preferably, for example, 1 to 50 wt % with respect to the entire aqueous solution, particularly preferably 1 to 10 wt %, for further improvement in the hand feeling of the treated fibrous material. The crosslinking compounds may be used alone or in combination of two or more. If two or more kinds of crosslinking compounds are used, the total amount thereof is preferably in the range above.

The method of adding the crosslinking compound is not particularly limited, if the aqueous solution can be dipped into the raw material; for example, the crosslinking compound may be added by a method similar to the addition method of the phosphorus-containing compound; and a method of dipping the raw material in an aqueous solution and squeezing it is preferably used.

The pick up of the aqueous crosslinking compound solution into the raw material is not particularly limited, if the object of the present invention is achieved, and normally, may be smaller when the concentration of the crosslinking compound in the aqueous solution is higher. On the other hand, the pick up is set to a larger value, when the concentration of the crosslinking compound is lower. For example, if the concentration of the aqueous solution is set to the concentration described above, the pick up is normally set to 50 to 100 wt %, preferably 60 to wt %. The temperature of the aqueous crosslinking compound solution is not particularly limited, and may be, for example, room temperature.

If a method of dipping the fibrous material in an aqueous solution and squeezing it is employed as the method of adding the aqueous crosslinking compound solution, the dipped raw material is squeezed until the pick up is achieved, and a mangle-squeezing method is preferably employed as the squeezing method.

The aqueous crosslinking compound solution may contain organic solvents and surfactants, as far as the object of the present invention is achieved. Organic solvents similar to those that may be contained in the aqueous phosphorus-containing compound solution can be used as the organic solvents.

Heat treatment may be carried out after the crosslinking treatment. It is because the heat treatment promotes reaction between the crosslinking compound and the excessive amino groups of the amine compound. The heat treatment may be simple drying or a drying-curing treatment. The drying is preferably carried out, for example, at a temperature of 100 to 150° C. for 30 seconds to 10 minutes. The curing treatment is preferably carried out, for example, at a temperature of 150 to 170° C. for 30 seconds to 5 minutes.

### EXAMPLES

### Experimental Example A

### Order (1)

### Example 1A

A mercerized 100% cotton fabric was irradiated onto one face with electron beam at an exposure dose of 40 kGy by means of an electrocurtain-type electron beam irradiation equipment EC250/15/180L (Iwasaki Electric Co., Ltd.) under nitrogen atmosphere. The fabric irradiated with the electron beam was dipped in an aqueous solution containing mono(2-methacryloyloxyethyl) phosphate (manufactured by Kyoeisha Chemical Co., Ltd.; trade name: Light-Ester P-1M; hereinafter, referred to as “P1M”) and ammonia mixed and dissolved therein respectively in amounts of 30 wt % and 1.2 wt % (aqueous phosphorus-based agent solution), and the fabric was squeezed with a mangle to a pick up of approximately 70 wt % and aged at 35° C. for 18 hours. Additionally, the fabric was irradiated once again onto the other unirradiated face with electron beam at an exposure dose of 40 kGy by means of the electrocurtain-type electron beam irradiation equipment EC250/15/180L (Iwasaki Electric Co., Ltd.) under nitrogen atmosphere. After irradiation, the fabric was aged at 35° C. for 2 hours. The fabric was then washed with water for removal of unreacted agents. Subsequently, the fabric was dipped in an aqueous solution containing polyethyleneimine (manufactured by Nippon Shokubai Co., Ltd. Co., Ltd.; trade name: Epomin SP-006; hereinafter referred to as “SP006”) mixed and dissolved in an amount of 10 wt % (aqueous amine-based agent solution), squeezed with a mangle to a pick up of approximately 70 wt % to the fabric, and aged at 35° C. for hours. The fabric was then washed with water for removal of unreacted agents, and dried at 80° C. for 1 hour.

### Examples 2A to 8A

A treatment similar to that in Example 1A was carried out, except that an aqueous phosphorus-based agent solution and an aqueous amine-based agent solution respectively having compositions shown in Table 1 were used.

### Example 9A

A treatment similar to that in Example 1A was carried out, except that P-1M was replaced with bis(2-methacryloyloxyethyl) phosphate (manufactured by Kyoeisha Chemical Co., Ltd.; trade name: Light-Ester P-2 M; hereinafter referred to as “P2M”).

### Comparative Example 1A

A treatment similar to that in Example 1A was carried out, except that the fabric was not treated with the aqueous amine-based agent solution.

### Comparative Example 2A

A treatment similar to that in Example 1A was carried out, except that no electron beam treatment was carried out.

Evaluation

Flame Retardance

The flame retardance was evaluated by using a treated fabric that was previously processed in a particular washing test and dried. In the washing test, the fabric was washed 30 times or 50 times, by a method according to the approval standard of the incorporated foundation of Japan Fire Retardant Association. In the flame retardance test, carbonization length was measured by a test method in accordance with the combustibility test method approved by the incorporated foundation of Japan Fire Retardant Association for evaluation of flame-proofed fabric and other products (so-called vertical methane burner method). Fabrics not completely burned were ranked as “◯”, and those completely burned as “X”. The carbonization length [mm] is specifically the length of the combustion area of the sample, and shorter length means higher flame retardance.

Phosphorus Content

The phosphorus content of the treated fabric was determined by using a scanning fluorescent X-ray analyzer ZSX 100e (manufactured by Rigaku Corporation).

Hand Feeling

The hand feeling of the treated fabric was evaluated.

◯; Very soft in hand-feeling of the fabric and suitable for use as clothing;

Δ; Soft in hand-feeling of the fabric and usable as clothing;

X; Hard in hand-feeling of the fabric and not usable as clothing.

TABLE 1
aftertreatment

| | aqueous phosphorus-based | | aqueous amine-based | | flame retardance* | | | |
|---|---|---|---|---|---|---|---|---|
| | agent solution | | agent solution | | (carbonization length[mm]) | | phosphorus | |
| | | concentration[%] | | concentration[%] | 30 times | 50 times | content | hand |
| | agents | the other is water | agents | the other is water | of washing | of washing | (wt %) | feeling |
| Example 1A | P1M + ammonia | 30 + 1.2 | SP006 | 10 | — | ◯ (43) | 0.9 | ◯ |
| Example 2A | P1M + ammonia | 30 + 1.2 | SP006 | 20 | — | ◯ (50) | 0.9 | ◯ |
| Example 3A | P1M | 30 | SP006 | 20 | — | ◯ (70) | 0.9 | ◯ |
| Example 4A | P1M + ammonia | 30 + 1.2 | SP012 | 10 | — | ◯ (53) | 0.9 | ◯ |
| Example 5A | P1M + ammonia | 30 + 1.2 | SP012 | 20 | — | ◯ (44) | 0.9 | ◯ |
| Example 6A | P1M | 30 | SP012 | 20 | — | ◯ (60) | 0.9 | ◯ |
| Example 7A | P1M + ammonia | 30 + 1.2 | PAA03 | 4 | — | ◯ (35) | 0.9 | ◯ |
| Example 8A | P1M + ammonia | 30 + 1.2 | Neofix F | 20 | — | ◯ (20) | 0.9 | ◯ |
| Example 9A | P2M + ammonia | 30 + 0.8 | PAA03 | 4 | — | ◯ (80) | 0.8 | ◯ |
| Comparative | P1M + ammonia | 30 + 1.2 | — | — | X | X | 0.9 | ◯ |
| Example 1A | | | | | | | | |
| Comparative | P1M + ammonia | 30 + 1.2 | SP006 | 10 | X | X | 0.9 | ◯ |
| Example 2A** | | | | | | | | |

*Flame retardance shows the evaluation result after the washing test.
**No electron beam treatment was carried out.

### Experimental Example B

### Order (2)

### Example 1B

A mercerized 100% cotton fabric was dipped in an aqueous solution of polyethyleneimine (manufactured by Nippon Shokubai Co., Ltd.; trade name: Epomin SP-006; hereinafter referred to as “SP006”) mixed and dissolved at a concentration of 20 wt % (aqueous amine-based agent solution), squeezed with a mangle to a pick up of approximately 70 wt %, and aged at 35° C. for 18 hours. The fabric was then irradiated on one face with electron beam at an exposure dose of 40 kGy by means of an electrocurtain-type electron beam irradiation equipment EC250/15/180L (Iwasaki Electric Co., Ltd.) under nitrogen atmosphere. The fabric irradiated with electron beam was dipped in an aqueous solution containing mono(2-methacryloyloxyethyl) phosphate (manufactured by Kyoeisha Chemical Co., Ltd.; trade name: Light-Ester P-1 M; hereinafter, referred to as “P1M”) at 30 wt % and ammonia at 1.2 wt % mixed and dissolved (aqueous phosphorus-based agent solution), squeezed with a mangle to a pick up of approximately 70 wt %, and dried at 35° C. for 18 hours. Then, the fabric was irradiated once again onto the other unirradiated face with electron beam at an exposure dose of 40 kGy by means of the electrocurtain-type electron beam irradiation equipment EC250/15/180L (Iwasaki Electric Co., Ltd.) under nitrogen atmosphere. After irradiation, the fabric was aged at 35° C. for 2 hours. The fabric was then washed with water for removal of unreacted agents and dried at 80° C. for 1 hour.

### Examples 2B to 4B

A treatment similar to that in Example 1B was carried out, except that an aqueous amine-based agent solution and an aqueous phosphorous-based agent solution having the composition shown in Table 2 were used.

Evaluation

Evaluation was performed by a method similar to those in Experimental Example A, except that the flame retardance was evaluated by the following method.

(Flame Retardance)

The flame retardance was evaluated by using a treated fabric that was previously subjected to a particular hot water test and then dried. In the hot water test, the fabric was shaken in aqueous 0.3 wt % calcium chloride solution at a bath ratio of 30:1 at 60° C. for 2 hours. The flame-retardant test method was the same as that used in Experimental Example A.

TABLE 2
pretreatment

| | aqueous amine-based | | aqueous phosphorus-based | | | | |
|---|---|---|---|---|---|---|---|
| | agent solution | | agent solution | | | phosphorus | |
| | | concentration[%] | | concentration[%] | flame retardance** | content | hand |
| | agents | the other is water | agents | the other is water | (carbonization length[mm]) | (wt %) | feeling |
| Example 1B | SP006 | 20 | P1M + ammonia | 30 + 1.2 | ◯ (135) | 0.9 | ◯ |
| Example 2B | SP012 | 20 | P1M + ammonia | 30 + 1.2 | ◯ (104) | 0.9 | ◯ |
| Example 3B | SP018 | 20 | P1M + ammonia | 30 + 1.2 | ◯ (90) | 0.9 | ◯ |
| Example 4B | PAA03 | 20 | P1M + ammonia | 30 + 1.2 | ◯ (40) | 0.9 | ◯ |

**Flame retardance shows the evaluation result after the hot water test.

### Experimental Example C

### Order (3)

### Example 1C

A mercerized 100% cotton fabric was irradiated onto one face with electron beam at an exosure dose of 40 kGy by means of an electrocurtain-type electron beam irradiation equipment EC250/15/180L (Iwasaki Electric Co., Ltd.) under nitrogen atmosphere. The fabric irradiated with the electron beam was dipped in an aqueous solution containing mono(2-methacryloyloxyethyl) phosphate (manufactured by Kyoeisha Chemical Co., Ltd.; trade name: Light-Ester P-1M; hereinafter, referred to as “P1M”) at 50 wt % and ammonia at 15 wt % mixed and dissolved therein (aqueous mixed agent solution), squeezed with a mangle to a pick up of approximately 70 wt % to the fabric, and aged at 35° C. for 18 hours. Additionally, the fabric was irradiated once again onto the other unirradiated face with electron beam at an exosure dose of 40 kGy by means of the electrocurtain-type electron beam irradiation equipment EC250/15/180L (Iwasaki Electric Co., Ltd.) under nitrogen atmosphere. After irradiation, the fabric was aged at 35° C. for 2 hours, washed with water for removal of unreacted agents, and then dried at 80° C. for 1 hour.

### Examples 2C to 14C

A treatment similar to that in Example 1C was carried out, except that an aqueous mixed agent solution having the composition shown in Table 3 was used.

Evaluation

Evaluation was performed by methods similar to those in Experimental Example A.

TABLE 3
treatment in the same bath

| | aqueous solution | | flame retardance* | | | | |
|---|---|---|---|---|---|---|---|
| | containing mixed agent | | (carbonization length[mm]) | | | phosphorus | |
| | | concentration[%] | 30 times | 50 times | | content | hand |
| | agents | the other is water | of washing | of washing | | (wt %) | feeling |
| Example 1C | P1M + ammonia | 50 + 4.2 | ◯ (42) | X | (all burnt) | 1.8 | X |
| Example 2C | P1M + ammonia | 55 + 4.8 | ◯ (44) | ◯ | (48) | 2 | X |
| Example 3C | P1M + glycine + ammonia | 55 + 15 + 17 | ◯ (49) | X | (all burnt) | 1.8 | X |
| Example 4C | P1M + guanidine carbonate | 55 + 25 | ◯ (46) | ◯ | (40) | 1.8 | X |
| Example 5C | P1M + monoethanolamine | 55 + 15 | ◯ (49) | X | (all burnt) | 1.8 | X |
| Example 6C | P1M + ethylenediamine | 30 + 4.3 | ◯ (44) | X | (all burnt) | 0.9 | ◯ |
| Example 7C | P1M + ethylenediamine | 40 + 5.8 | ◯ (29) | ◯ | (24) | 1.1 | Δ |
| Example 8C | P1M + ethylenediamine | 50 + 7.2 | ◯ (28) | ◯ | (29) | 1.4 | X |
| Example 9C | P1M + hexamethylenediamine | 30 + 8.4 | ◯ (57) | X | (all burnt) | 0.9 | ◯ |
| Example 10C | P1M + hexamethylenediamine | 40 + 11.2 | ◯ (33) | ◯ | (27) | 1.1 | Δ |
| Example 11C | P1M + SP012 | 30 + 7.5 | ◯ (31) | ◯ | (99) | 0.9 | ◯ |
| Example 12C | P1M + SP012 | 40 + 10 | ◯ (35) | ◯ | (65) | 1.1 | Δ |
| Example 13C | P1M + PAA03 | 30 + 3 | ◯ (33) | ◯ | (105) | 0.9 | ◯ |
| Example 14C | P1M + PAA03 | 40 + 4 | ◯ (30) | ◯ | (67) | 1.1 | Δ |

*Flame retardance shows the evaluation result after the washing test.

### Example 10

A treatment similar to that in Example 1A was carried out, except that an aqueous amine-based agent solution containing 10 wt % polyallylamine (manufactured by Nitto Boseki Co., Ltd.; trade name: PAA03; molecular weight: 3000; hereinafter referred to as “PAA03”) was used.

### Examples 5D, 9D and 13D

A treatment similar to that in Example 1D was carried out, except that an aqueous amine-based agent solution having the composition shown in Table 4 was used.

### Example 2D

A mercerized 100% cotton fabric was irradiated onto one face with electron beam at an exosure dose of 40 kGy in an electrocurtain-type electron beam irradiation equipment EC250/15/180L (Iwasaki Electric Co., Ltd.) under nitrogen atmosphere. The fabric irradiated with the electron beam was dipped by an aqueous solution containing “P1M” at 30 wt % and ammonia at 1.2 wt % mixed and dissolved therein (aqueous phosphorus-based agent aqueous solution), squeezed with a mangle to a pick up of approximately 70 wt %, and aged at 35° C. for 18 hours. Additionally, the fabric was irradiated once again onto the other unirradiated face with electron beam at an exosure dose of 40 kGy by means of the electrocurtain-type electron beam irradiation equipment EC250/15/180L (Iwasaki Electric Co., Ltd.) under nitrogen atmosphere. After irradiation, the fabric was aged at 35° C. for 2 hours. The fabric was then washed with water for removal of unreacted agents. Subsequently, the fabric was dipped in an aqueous solution containing “PAA-03” at 10 wt % mixed and dissolved therein (aqueous amine-based agent solution), squeezed with a mangle to a pick up of approximately 70 wt % to the fabric, and aged at 35° C. for hours. The fabric was then washed with water for removal of unreacted agents and dried at 80° C. for 1 hour. Then, the fabric was dipped in an aqueous solution containing polyglycerol polyglycidyl ether (manufactured by Nagase Chemtex Co., Ltd.; trade name: EX-313; hereinafter, referred to as “EX-313”) at 2.5 wt % mixed and dissolved therein (aqueous crosslinking agent solution), squeezed with a mangle to a pick up of approximately 70 wt % to the fabric, and treated at 130° C. for 90 seconds.

### Examples 3D, 4D, 6D to 8D, 10D to 12D, and 14D to 16D

A treatment similar to that in Example 2D was carried out, except that an amine-based agent and a crosslinking agent having the composition shown in Table 4 were used. “PAA-05” represents a polyallylamine (manufactured by Nitto Boseki Co., Ltd.; trade name: PAA-05; molecular weight: 5000).

Evaluation

Evaluation was made by methods similar to those in Example A. Results are shown in Table 4. In Examples 3D, 4D, 6D to 8D, 10D to 12D and 14D to 16D which were subjected to the crosslinking step, the amine compounds, which were crosslinked, were added to the fibrous material more tightly and improved the durability in flame retardance of the fibrous material compared to Examples 5D, 9D and 13D that were not subjected to the crosslinking step.

TABLE 4

| | | | | | | | flame retardance* | | |
|---|---|---|---|---|---|---|---|---|---|
| | aqueous phosphorus-based | | aqueous amine-based | | aqueous crosslinking | | (carbonization | phos- | |
| | agent solution | | agent solution | | agent solution | | length[mm]) | phorus | hand |
| | | concentration[%] | | concentration[%] | | concentration[%] | 50 times | content | feel- |
| | agents | the other is water | agents | the other is water | agents | the other is water | of washing | (wt %) | ing |
| Example 1D | P1M + ammonia | 30 + 1.2 | PAA-03 | 10 | EX-313 | 0 | ◯ (50) | 0.9 | ◯ |
| Example 2D | P1M + ammonia | 30 + 1.2 | PAA-03 | 10 | EX-313 | 2.5 | ◯ (10) | 0.9 | ◯ |
| Example 3D | P1M + ammonia | 30 + 1.2 | PAA-03 | 10 | EX-313 | 5 | ◯ (11) | 0.9 | ◯ |
| Example 4D | P1M + ammonia | 30 + 1.2 | PAA-03 | 10 | EX-313 | 10 | ◯ (24) | 0.9 | ◯ |
| Example 5D | P1M + ammonia | 30 + 1.2 | PAA-03 | 20 | EX-313 | 0 | ◯ (40) | 0.9 | ◯ |
| Example 6D | P1M + ammonia | 30 + 1.2 | PAA-03 | 20 | EX-313 | 2.5 | ◯ (11) | 0.9 | ◯ |
| Example 7D | P1M + ammonia | 30 + 1.2 | PAA-03 | 20 | EX-313 | 5 | ◯ (12) | 0.9 | ◯ |
| Example 8D | P1M + ammonia | 30 + 1.2 | PAA-03 | 20 | EX-313 | 10 | ◯ (26) | 0.9 | ◯ |
| Example 9D | P1M + ammonia | 30 + 1.2 | PAA-05 | 10 | EX-313 | 0 | ◯ (50) | 0.9 | ◯ |
| Example 10D | P1M + ammonia | 30 + 1.2 | PAA-05 | 10 | EX-313 | 2.5 | ◯ (12) | 0.9 | ◯ |
| Example 11D | P1M + ammonia | 30 + 1.2 | PAA-05 | 10 | EX-313 | 5 | ◯ (11) | 0.9 | ◯ |
| Example 12D | P1M + ammonia | 30 + 1.2 | PAA-05 | 10 | EX-313 | 10 | ◯ (27) | 0.9 | ◯ |
| Example 13D | P1M + ammonia | 30 + 1.2 | PAA-05 | 20 | EX-313 | 0 | ◯ (40) | 0.9 | ◯ |
| Example 14D | P1M + ammonia | 30 + 1.2 | PAA-05 | 20 | EX-313 | 2.5 | ◯ (11) | 0.9 | ◯ |
| Example 15D | P1M + ammonia | 30 + 1.2 | PAA-05 | 20 | EX-313 | 5 | ◯ (13) | 0.9 | ◯ |
| Example 16D | P1M + ammonia | 30 + 1.2 | PAA-05 | 20 | EX-313 | 10 | ◯ (26) | 0.9 | ◯ |

*Flame retardance shows the evaluation result after the washing test.

1. A flame-retardant processing method, comprising:
a radiation processing step of irradiating a cellulosic fiber material with radiation;
a phosphorus processing step of adding a radically polymerizable phosphorus-containing compound to the cellulosic fiber material; and
an amine processing step of adding an amine compound to the cellulosic fiber material.

2. The flame-retardant processing method of claim 1,
wherein the phosphorus processing step is carried out after the radiation processing step,
wherein the amine processing step is carried out before the radiation processing step, at the same time in the same bath as the phosphorus treatment step, or after the phosphorus treatment step.

3. The flame-retardant processing method of claim 1 or claim 2, wherein the amine compound is a low-molecular weight compound having a molecular weight of less than 300 or a high-molecular weight compound having a molecular weight of 300 or more, being able to form ammonium ion in water.

4. The flame-retardant processing method of claim 3, wherein the low-molecular weight amine compound is selected from ammonia, ammonium salts, aliphatic monoamines, aromatic monoamines, heterocyclic monoamines, aliphatic polyamines, aromatic polyamines and heterocyclic polyamines, and the high-molecular weight amine compound is an amino-group-containing polymer.

5. The flame-retardant processing method of claim 1, further comprising a crosslinking step in which a crosslinking compound is added to the cellulosic fiber material after the radiation processing step, the phosphorus processing step and the amine processing step.

6. The flame-retardant processing method of claim 5, wherein the crosslinking compound is selected from multifunctional epoxy group-containing compounds, glyoxal resins or a mixture thereof.

7. A flame-retarded cellulosic fiber material, prepared through the flame-retardant processing method of claim 1.

8. A flame-retarded cellulosic fiber material, wherein a radically polymerizable phosphorus-containing compound is bound to a cellulosic fiber in addition reaction and an amine compound is bound ionically to the bound and radically polymerizable phosphorus-containing compound.

9. The cellulosic fiber material of claim 7 or claim 8, wherein a phosphorus content is 2.0 wt % or less.

10. A flame-retarding agent set for radiation treatment, comprising a radically polymerizable phosphorus-containing compound and an amine compound.
